(19) United States
(12) Patent Application Publication
(10) Pub. No.: US 2026/0204114 A1
(43) Pub. Date: Jul. 16, 2026

(54) METHOD AND SYSTEM FOR INTELLIGENT OPERATION AND MAINTENANCE OF FINGERPRINT ACCESS CONTROL

(71) Applicant: HANGZHOU SYNOCHIP DATA SECURITY TECHNOLOGY CO., LTD, Hangzhou, Zhejiang (CN)

(72) Inventors: Hongchang LUO, Hangzhou (CN); Feifei ZHANG, Hangzhou (CN); Peng QIAN, Hangzhou (CN)

(73) Assignee: HANGZHOU SYNOCHIP DATA SECURITY TECHNOLOGY CO., LTD, Hangzhou, Zhejiang (CN)

(21) Appl. No.: 19/138,016

(22) PCT Filed: Nov. 20, 2023
(86) PCT No.: PCT/CN2023/132696

§ 371 Date: Jun. 11, 2025

(30) Foreign Application Priority Data
Nov. 15, 2023 (CN) 202311518704.3

(51) Int. Cl. G07C 9/00; G06V 10/98; G06V 40/12; G06V 40/50; G07C 9/37

(52) U.S. Cl. CPC G07C 9/00563; G06V 10/993; G06V 40/1365; G06V 40/50; G07C 9/37; G07C 2209/08

(57) ABSTRACT

A method and system for intelligent operation and maintenance of fingerprint access control, including: real-time acquisition of fingerprint identification data information of the fingerprint access control during each operation and maintenance monitoring time period; utilizing the fingerprint identification data information at the end of each time period to obtain a running quality assessment factor corresponding to the time period; when the running quality assessment factor corresponding to a current preceding time period is lower than a preset factor threshold, then utilizing the running quality assessment factors corresponding to each time period to obtain a running quality assessment parameter for the current fingerprint access control; when the running quality assessment parameter is lower than a preset assessment parameter threshold, then sending a prompt for performing operation and maintenance on the fingerprint access control to a staff terminal. The system includes modules corresponding to the steps of the method.

### TECHNICAL FIELD

The present invention relates to the field of fingerprint access control technology, and particularly relates to a method and system for intelligent operation and maintenance of fingerprint access control.

### BACKGROUND ART

With the advancement of technology, fingerprint access control has become security equipment in many places and is widely applied in places such as companies, residential areas, and schools. In order to ensure the normal operation of the fingerprint access control system, it needs to undergo regular operation and maintenance management.

However, existing operation and maintenance management methods have numerous problems. First, existing operation and maintenance management often relies on manual inspection, which not only consumes manpower but also has low efficiency, and cannot discover and solve problems in a timely manner. Second, due to the lack of effective data support, it is impossible to scientifically evaluate the running status of the fingerprint access control system, resulting in poor operation and maintenance effectiveness.

Therefore, there is an urgent need for a method for intelligent operation and maintenance of fingerprint access control based on big data analysis and artificial intelligence technology, to achieve efficient operation and maintenance management and scientific running status evaluation.

### DISCLOSURE OF INVENTION

The present invention provides a method and system for intelligent operation and maintenance of fingerprint access control, to solve problems such as passivity, low maintenance efficiency, difficulty in identifying safety hazards, and high costs in the operation and maintenance of traditional access control systems:

A method for intelligent operation and maintenance of fingerprint access control proposed by the present invention, the said method for intelligent operation and maintenance of fingerprint access control comprises:
S1: real-time acquisition of fingerprint identification data information of the fingerprint access control during each operation and maintenance monitoring time period;
S2: utilizing the said fingerprint identification data information at the end of each said operation and maintenance monitoring time period to obtain a running quality assessment factor corresponding to the said operation and maintenance monitoring time period;
S3: when the running quality assessment factor corresponding to a current preceding said operation and maintenance monitoring time period is lower than a preset factor threshold, then utilizing the running quality assessment factors corresponding to each said operation and maintenance monitoring time period to obtain a running quality assessment parameter for the current fingerprint access control;
S4: when the said running quality assessment parameter is lower than a preset assessment parameter threshold, then sending a prompt for performing operation and maintenance on the said fingerprint access control to a staff terminal.

Further, the real-time acquisition of fingerprint identification data information of the fingerprint access control during each operation and maintenance monitoring time period comprises:
S11: setting an operation and maintenance monitoring time period; wherein the value range of the said operation and maintenance monitoring time period is 90 days to 180 days;
S12: real-time acquisition of fingerprint identification data information of the fingerprint access control during each said operation and maintenance monitoring time period; wherein the said data information includes the accuracy of fingerprint identification, the response time length of each fingerprint identification, and the number of fingerprint identifications experienced by a single user to complete one access control opening and its corresponding fingerprint similarity determination result.

Further, utilizing the said fingerprint identification data information at the end of each said operation and maintenance monitoring time period to obtain the running quality assessment factor corresponding to the said operation and maintenance monitoring time period comprises:
S21: at the end of each said operation and maintenance monitoring time period, extracting the fingerprint identification data information of the fingerprint access control for a current preceding said operation and maintenance monitoring time period;
S22: utilizing the said fingerprint identification data information to obtain the running quality assessment factor corresponding to the said operation and maintenance monitoring time period.

Further, when the running quality assessment factor corresponding to a current preceding said operation and maintenance monitoring time period is lower than a preset factor threshold, then utilizing the running quality assessment factors corresponding to each said operation and maintenance time period to obtain the running quality assessment parameter for the current fingerprint access control comprises:
S31: when the running quality assessment factor corresponding to a current preceding said operation and maintenance monitoring time period is lower than a preset factor threshold, extracting the running quality assessment factors corresponding to all said operation and maintenance monitoring time periods experienced between the operation and maintenance monitoring time period where a current running quality assessment factor is lower than the preset factor threshold and the operation and maintenance monitoring time period where a previous running quality assessment factor was lower than the preset factor threshold, to form a factor set;
S32: extracting the running quality assessment factors from the said factor set that are lower than a preset reference factor value and consolidating them into a first factor array;
S33: utilizing the said first factor array to set a first factor influence coefficient;
S34: extracting the running quality assessment factors from the said factor set that are not lower than the preset reference factor value and consolidating them into a second factor array;
S35: utilizing the said second factor array to set a second factor influence coefficient; and
S36: utilizing the said first factor influence coefficient and the said second factor influence coefficient in combination with all running quality assessment factors in the factor set to obtain the running quality assessment parameter for the current fingerprint access control.

Further, utilizing the said first factor influence coefficient and the said second factor influence coefficient in combination with all running quality assessment factors in the factor set to obtain the running quality assessment parameter for the current fingerprint access control comprises:
S316: extracting the said first factor influence coefficient and the said second factor influence coefficient;
S362: extracting all running quality assessment factors from the said factor set;
S363: utilizing all running quality assessment factors in the said factor set to obtain a running quality assessment parameter baseline value; and
S364: utilizing the said assessment parameter baseline value in combination with the first factor influence coefficient and the second factor influence coefficient to obtain the running quality assessment parameter for the current fingerprint access control.

A system for intelligent operation and maintenance of fingerprint access control proposed by the present invention, the said system for intelligent operation and maintenance of fingerprint access control comprises:
an Information Collection Module, configured to real-time acquire fingerprint identification data information of the fingerprint access control during each operation and maintenance monitoring time period;
a Quality Assessment Module, configured to utilize the said fingerprint identification data information at the end of each said operation and maintenance monitoring time period to obtain a running quality assessment factor corresponding to the said operation and maintenance monitoring time period;
a Parameter Acquisition Module, configured to, when the running quality assessment factor corresponding to a current preceding said operation and maintenance monitoring time period is lower than a preset factor threshold, then utilize the running quality assessment factors corresponding to each said operation and maintenance monitoring time period to obtain a running quality assessment parameter for the current fingerprint access control; and
a Maintenance Prompt Module, configured to, when the said running quality assessment parameter is lower than a preset assessment parameter threshold, then send a prompt for performing operation and maintenance on the said fingerprint access control to a staff terminal.

Further, the said Information Collection Module comprises:
a Time Setting Module, configured to set an operation and maintenance monitoring time period; wherein the value range of the said operation and maintenance monitoring time period is 90 days to 180 days; and
a Data Acquisition Module, configured to real-time acquire fingerprint identification data information of the fingerprint access control during each said operation and maintenance monitoring time period; wherein the said data information includes the accuracy of fingerprint identification, the response time length of each fingerprint identification, and the number of fingerprint identifications experienced by a single user to complete one access control opening and its corresponding fingerprint similarity determination result.

Further, the said Quality Assessment Module comprises:
an Information Extraction Module, configured to, at the end of each said operation and maintenance monitoring time period, extract the fingerprint identification data information of the fingerprint access control for a current preceding said operation and maintenance monitoring time period; and
a Quality Assessment Module, configured to utilize the said fingerprint identification data information to obtain the running quality assessment factor corresponding to the said operation and maintenance monitoring time period.

Further, the said Parameter Acquisition Module comprises:
a Set Formation Module, configured to, when the running quality assessment factor corresponding to a current preceding said operation and maintenance monitoring time period is lower than a preset factor threshold, extract the running quality assessment factors corresponding to all said operation and maintenance monitoring time periods experienced between the operation and maintenance monitoring time period where a current running quality assessment factor is lower than the preset factor threshold and the operation and maintenance monitoring time period where a previous running quality assessment factor was lower than the preset factor threshold, to form a factor set;
a First Factor Array Module, configured to extract the running quality assessment factors from the said factor set that are lower than a preset reference factor value and consolidate them into a first factor array;
a First Factor Influence Coefficient Module, configured to utilize the said first factor array to set a first factor influence coefficient;
a Second Factor Array Module, configured to extract the running quality assessment factors from the said factor set that are not lower than the preset reference factor value and consolidate them into a second factor array;
a Second Factor Influence Coefficient Module, configured to utilize the said second factor array to set a second factor influence coefficient; and
an Operation Quality Assessment Module, configured to utilize the said first factor influence coefficient and the said second factor influence coefficient in combination with all running quality assessment factors in the factor set to obtain the running quality assessment parameter for the current fingerprint access control.

Further, the said Operation Quality Assessment Module comprises:
a Coefficient Extraction Module, configured to extract the said first factor influence coefficient and the said second factor influence coefficient;
a Factor Extraction Module, configured to extract all running quality assessment factors from the said factor set;
a Baseline Value Acquisition Module, configured to utilize all running quality assessment factors in the said factor set to obtain a running quality assessment parameter baseline value; and
an Assessment Parameter Acquisition Module, configured to utilize the said assessment parameter baseline value in combination with the first factor influence coefficient and the second factor influence coefficient to obtain the running quality assessment parameter for the current fingerprint access control.

Beneficial effects of the present invention: By real-time acquiring fingerprint identification data information of the fingerprint access control during each operation and maintenance monitoring time period, it is possible to comprehensively understand the running status of the equipment and the quality of fingerprint identification, providing sufficient data support for subsequent evaluation and maintenance; utilizing the said fingerprint identification data information to obtain the running quality assessment factor corresponding to each operation and maintenance monitoring time period helps to objectively evaluate the running quality of the access control system and provides an objective basis for further maintenance decisions; when the running quality assessment factor is lower than a preset factor threshold, the system can automatically determine that the operation of the access control system is abnormal, and then obtain the running quality assessment parameter for the current fingerprint access control. This enables intelligent monitoring and early warning of the running status of the access control system, helping to discover potential problems and handle them at an early stage; when the running quality assessment parameter is lower than a preset assessment parameter threshold, the system will send a prompt for performing operation and maintenance on the fingerprint access control to a staff terminal, thereby improving maintenance response speed, avoiding potential faults from developing into actual faults, and reducing maintenance costs and losses; by collecting and analyzing the running quality assessment parameters, running quality data of the fingerprint access control system can be formed, helping to formulate more reasonable maintenance plans and improving the targetedness and effectiveness of maintenance. Since fingerprint identification technology is adopted, it can effectively avoid illegal intrusion and security vulnerabilities.

### DESCRIPTION OF DRAWINGS

FIG. 1 is a flowchart of the method steps for intelligent operation and maintenance of fingerprint access control according to the present invention;

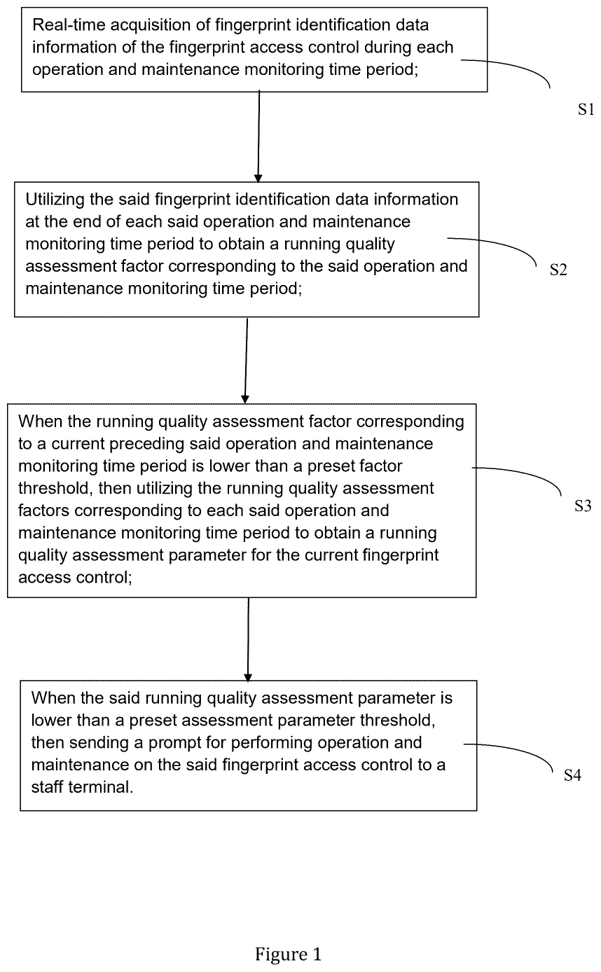

FIG. 2 is a module diagram of the system for intelligent operation and maintenance of fingerprint access control according to the present invention.

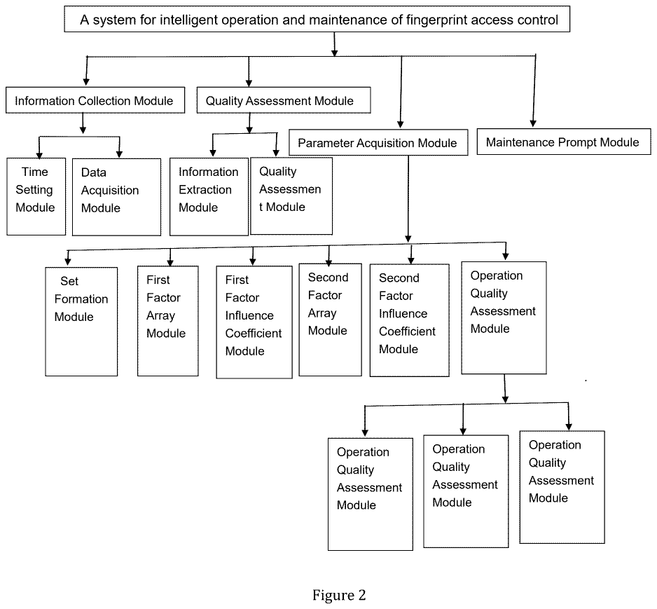

### DETAILED DESCRIPTION

Preferred embodiments of the present invention are described below in conjunction with the accompanying drawings. It should be understood that the preferred embodiments described herein¹ are only used to illustrate and explain the present invention, and are not intended to limit the present invention.²

### Example 1

In this example, a method for intelligent operation and maintenance of fingerprint access control, the said method for intelligent operation and maintenance of fingerprint access control comprises:
S1: real-time acquisition of fingerprint identification data information of the fingerprint access control during each operation and maintenance monitoring time period;
S2: utilizing the said fingerprint identification data information at the end of each said operation and maintenance monitoring time period to obtain a running quality assessment factor corresponding to the said operation and maintenance monitoring time period;
S3: when the running quality assessment factor corresponding to a current preceding said operation and maintenance monitoring time period is lower than a preset factor threshold, then utilizing the running quality assessment factors corresponding to each said operation and maintenance monitoring time period to obtain a running quality assessment parameter for the current fingerprint access control;
S4: when the said running quality assessment parameter is lower than a preset assessment parameter threshold, then sending a prompt for performing operation and maintenance on the said fingerprint access control to a staff terminal.

The working principle of the above technical solution is: By real-time acquiring fingerprint identification data information of the fingerprint access control, and then calculating the running quality assessment factor based on this data information. At the end of each operation and maintenance monitoring time period, according to the said fingerprint identification data information, the running quality assessment factor corresponding to that time period is calculated. If the running quality assessment factor is lower than a preset factor threshold, it indicates that there may be problems with the running quality of the fingerprint access control. In order to further evaluate the running status of the fingerprint access control, when the running quality assessment factor corresponding to an operation and maintenance monitoring time period is lower than a preset factor threshold, the running quality assessment parameter for the current fingerprint access control is obtained based on the running quality assessment factor of this time period. If the running quality assessment parameter is lower than a preset assessment parameter threshold, it indicates that there are significant problems with the running quality of the fingerprint access control. When the running quality assessment parameter of the fingerprint access control is lower than a preset assessment parameter threshold, a prompt for performing operation and maintenance on the said fingerprint access control will be sent to a staff terminal. This allows timely discovering and solving problems in the operation of the fingerprint access control, ensuring its normal operation and security.

The effects of the above technical solution are: By real-time acquiring fingerprint identification data information, it is possible to timely understand the usage and data statistics of the fingerprint access control equipment, which is beneficial for timely discovering problems and making operation and maintenance adjustments. Utilizing fingerprint identification data information to obtain the running quality assessment factor allows for objective evaluation of the running status of the fingerprint access control equipment, better understanding its stability and reliability. When the running quality assessment factor is lower than a preset factor threshold, the running quality assessment parameter can be obtained according to the said factor, further understanding the running quality of the fingerprint access control equipment. When the running quality assessment parameter is lower than a preset assessment parameter threshold, a prompt for operation and maintenance can be timely sent to a staff terminal, helping staff to timely troubleshoot and ensure the normal operation of the equipment. Through this solution, it is possible to improve the running efficiency and stability of the fingerprint access control equipment, reduce the probability of faults occurring, and improve the effectiveness of security and operating costs. By real-time monitoring the running status of the fingerprint access control, it is possible to timely discover potential problems, take preventive maintenance measures, avoid equipment damage or failure, and improve the lifespan and stability of the equipment; at the same time, by evaluating the running quality of the fingerprint access control, it is possible to understand the performance status of the equipment, optimize resource allocation, investing limited resources where they are most needed, and improving resource utilization efficiency; by real-time acquiring fingerprint identification data information and evaluating the running quality, it is possible to timely discover and solve potential security problems, enhance the security of the fingerprint access control system, and improve the security level; by analyzing and mining the collected fingerprint identification data information, more information and knowledge can be obtained, providing support and reference for decision-making and improving the scientificity and accuracy of decision-making.

### Example 2

In this example, the real-time acquisition of fingerprint identification data information of the fingerprint access control during each operation and maintenance monitoring time period comprises:
S11: setting an operation and maintenance monitoring time period; wherein the value range of the said operation and maintenance monitoring time period is 90 days to 180 days;
S12: real-time acquisition of fingerprint identification data information of the fingerprint access control during each said operation and maintenance monitoring time period; wherein the said data information includes the accuracy of fingerprint identification, the response time length of each fingerprint identification, and the number of fingerprint identifications experienced by a single user to complete one access control opening and its corresponding fingerprint similarity determination result.

The working principle of the above technical solution is: setting the start and end time of each operation and maintenance monitoring time period in the system, wherein the value range of this time period is 90 days to 180 days. Operation and maintenance monitoring of the fingerprint access control will be performed during this period. Real-time acquisition of fingerprint identification data information: Within each operation and maintenance monitoring time period, the system real-time collects the fingerprint identification status of the fingerprint access control. The data information includes, but is not limited to, the accuracy of fingerprint identification, the response time length of each fingerprint identification, and the number of fingerprint identifications experienced by a single user during the access control opening process and its corresponding fingerprint similarity determination result, etc.

The effects of the above technical solution are: By setting the operation and maintenance time monitoring period, the frequency and duration of monitoring can be flexibly adjusted, meeting different scenarios and needs. By real-time acquiring fingerprint identification data information of the fingerprint access control, it is possible to timely understand the accuracy of fingerprint identification and monitor abnormal situations. If abnormal fingerprint identification activity occurs, immediate handling and response can be performed to improve the security of the access control system; by collecting the response time length of each fingerprint identification, the response speed of the access control system can be evaluated, and corresponding optimization can be performed based on the data results, improving user experience. Accurate fingerprint identification and a fast access control opening process can improve user satisfaction; by recording the number of fingerprint identifications experienced by a single user to complete one access control opening and its corresponding fingerprint similarity determination result, the fingerprint identification status of each user can be analyzed. This helps to detect the reliability of user fingerprint information and provide data support, helping to solve existing problems with fingerprint identification and improve identification accuracy; by continuously acquiring fingerprint identification data information of the fingerprint access control, operation and maintenance personnel can timely discover and solve potential problems and perform system operation and maintenance and optimization work based on the data results. This helps to improve the stability and reliability of the access control system, reducing the occurrence of faults and the impact on user usage.

### Example 3

In this example, utilizing the said fingerprint identification data information at the end of each said operation and maintenance monitoring time period to obtain the running quality assessment factor corresponding to the said operation and maintenance monitoring time period comprises:
S21: at the end of each said operation and maintenance monitoring time period, extracting the fingerprint identification data information of the fingerprint access control for a current preceding said operation and maintenance monitoring time period;
S22: utilizing the said fingerprint identification data information to obtain the running quality assessment factor corresponding to the said operation and maintenance monitoring time period.

Wherein, the said running quality assessment factor is obtained through the following formula:

$$E = ( 1 + ln ( {e}^{P} + \frac{1}{n} \cdot {\sum }_{i = 1}^{n} ( \frac{{T}_{i} - {T}_{i - 1}}{Δ T} - \frac{{T}_{y} - Δ T}{max ( Δ T , {T}_{y} )} ) - \sqrt{\frac{1}{m} \cdot {\sum }_{i = 1}^{m} {( ( 1 - \frac{1}{{N}_{xi}} ) - \frac{1}{m} \cdot {\sum }_{i = 1}^{m} ( 1 - \frac{1}{{N}_{xi}} ) )}^{2}} ) ) \cdot {E}_{0}$$

Wherein, E represents the running quality assessment factor;
E₀ represents the factor baseline value;
P represents the accuracy of fingerprint identification;
n represents the number of fingerprint identifications within the operation and maintenance monitoring time period;
Tᵢ represents the response time length corresponding to the i-th fingerprint identification;
ΔT represents the theoretical response time delay caused by the network communication channel increasing a unit amount of data processing (1G) per unit time (1 s);
T_{y} represents the maximum allowable response delay for fingerprint identification;
m represents the number of identified users within the operation and maintenance monitoring time period;
Nₛᵢ represents the average number of fingerprint verifications experienced by the i-th user required to pass one fingerprint identification;
E₀ represents the factor baseline value.

The working principle of the above technical solution is: At the end of each operation and maintenance monitoring time period, the fingerprint identification data information for a current preceding operation and maintenance monitoring time period is extracted from the fingerprint access control system. This data information may include the accuracy of fingerprint identification, response time length, and fingerprint similarity determination results, etc. Utilizing the extracted fingerprint identification data information, the running quality assessment factor corresponding to the operation and maintenance monitoring time period is calculated.

The effects of the above technical solution are: By obtaining fingerprint identification data information and calculating the running quality assessment factor, quantitative evaluation of the performance and running quality of the access control system can be performed. This helps to discover problems and anomalies in the system, timely take measures to repair or improve them, and improve the stability and reliability of the system; utilizing the extracted fingerprint identification data information, the running quality of each operation and maintenance monitoring time period can be real-time monitored. By timely obtaining the running quality assessment factor, it is possible to understand the performance differences of the system in different time periods, timely discover and solve running problems, and ensure the normal operation of the system; by obtaining the running quality assessment factor corresponding to each operation and maintenance monitoring time period, it can provide reference and basis for operation and maintenance personnel, assisting them in making decisions and optimization. For example, when the running quality in a certain time period is low, targeted system maintenance, technical adjustment, or equipment upgrade can be performed to improve the overall performance and stability of the system; through the monitoring and evaluation of fingerprint identification data information, problems with the accuracy and reliability of fingerprint identification can be discovered, thereby improving the security and accuracy of the access control system. Timely discovering and correcting fingerprint identification anomalies can prevent unauthorized personnel from entering the system and increase the security protection capability of the system. Through the above running quality assessment factor formula, the running quality assessment factor can be effectively calculated, comprehensively considering multiple factors, and flexibly adjusted according to needs, thereby helping operation and maintenance personnel to quantitatively evaluate the running quality of the system, timely discover problems and perform optimization. At the same time, the running quality assessment factor E in the formula can be calculated through parameters such as accuracy P, response time length Tᵢ, etc., capable of quantitatively evaluating the running quality of the system. In this way, operation and maintenance personnel can obtain a specific numerical value representing the quality level of the system's operation and use this as a baseline for monitoring and improvement; multiple factors are considered in the formula, including fingerprint identification accuracy, response time, processing capability of the communication channel, etc. In this way, the influence of factors from multiple aspects on system performance can be comprehensively considered, more comprehensively evaluating the running quality; the factor baseline value E₀ in the formula can be adjusted according to specific circumstances. When demand changes, the assessment requirements of the operation and maintenance monitoring time period can be flexibly adapted by adjusting the baseline value, thereby more accurately evaluating the running quality; the running quality assessment factor calculated by the formula can be compared with a preset threshold to determine whether the system is operating in a good state. When the factor is lower than the threshold, it indicates that there may be problems with the system, requiring corresponding optimization and improvement. In this way, the reasons for the decline in running quality can be timely discovered, and measures can be taken to solve them, improving the performance and stability of the system.

### Example 4

In this example, when the running quality assessment factor corresponding to a current preceding said operation and maintenance monitoring time period is lower than a preset factor threshold, then utilizing the running quality assessment factors corresponding to each said operation and maintenance monitoring time period to obtain the running quality assessment parameter for the current fingerprint access control comprises:
S31: when the running quality assessment factor corresponding to a current preceding said operation and maintenance monitoring time period is lower than a preset factor threshold, extracting the running quality assessment factors corresponding to all said operation and maintenance monitoring time periods experienced between the operation and maintenance monitoring time period where a current running quality assessment factor is lower than the preset factor threshold and the operation and maintenance monitoring time period where a previous running quality assessment factor was lower than the preset factor threshold, to form a factor set;
S32: extracting the running quality assessment factors from the said factor set that are lower than a preset reference factor value and consolidating them into a first factor array;
S33: utilizing the said first factor array to set a first factor influence coefficient; wherein the said first factor influence coefficient is obtained through the following formula:

$${x}_{1} = ( 1 + \frac{1}{{k}_{1}} \cdot {\sum }_{i = 1}^{{k}_{1}} ( 1 - {e}^{\frac{{E}_{e} - {E}_{i}}{{E}_{0}}} ) ) \cdot {X}_{0}$$

Here are the English translations for the variable definitions for the first factor influence coefficient formula:
Wherein, x₁ represents the first factor influence coefficient;
k₁ represents the number of factors in the first factor array;
E_{c} represents the reference factor value;
X₀ represents the coefficient baseline value;
e represents a constant, with a value of 2.71;
Eᵢ represents the factor value of the i-th factor in the first factor array;
S34: extracting the running quality assessment factors from the said factor set that are not lower than a preset reference factor value and consolidating them into a second factor array;
S35: utilizing the said second factor array to set a second factor influence coefficient; wherein the said second factor influence coefficient is obtained through the following formula:

$${x}_{2} = ( 1 + \frac{1}{{k}_{2} \cdot {x}_{1}} \cdot {\sum }_{i = 1}^{{k}_{2}} ( 1 + {e}^{\frac{{E}_{e} - {E}_{j}}{{E}_{0}}} ) ) \cdot {X}_{0}$$

Wherein, x₂ represents the second factor influence coefficient;
k₁ represents the number of factors in the first factor array;
E_{c} represents the reference factor value;
X₀ represents the coefficient baseline value;
e represents a constant, with a value of 2.71;
k₂ represents the number of factors in the second factor array;
Eⱼ represents the factor value of the j-th factor in the second factor array;
S36: utilizing the said first factor influence coefficient and the said second factor influence coefficient in combination with all running quality assessment factors in the factor set to obtain the running quality assessment parameter for the current fingerprint access control.

The working principle of the above technical solution is: According to a preset factor threshold, it is determined whether the running quality assessment factor within the current operation and maintenance monitoring time period is lower than the threshold. If it is lower than the threshold, it indicates that there are problems with the running quality of the system. When it is found that the current running quality assessment factor is lower than the threshold, it is necessary to extract the running quality assessment factors of all operation and maintenance monitoring time periods experienced between the operation and maintenance monitoring time period where the current running quality assessment factor is lower than the threshold and the previous operation and maintenance monitoring time period where the factor was lower than the threshold. This allows obtaining a factor set, which includes the running quality assessment factors that are continuously below the threshold. The running quality assessment factors in the factor set that are lower than a preset reference factor value are consolidated into a first factor array. This allows extracting a portion of the running quality assessment factors used for determining the first factor influence coefficient. The running quality assessment factors in the factor set that are not lower than a preset reference factor value are consolidated into a second factor array. This allows extracting a portion of the running quality assessment factors used for determining the second factor influence coefficient. The first factor array is utilized to set the first factor influence coefficient, and the second factor array is utilized to set the second factor influence coefficient. This allows assigning different influence coefficients according to the importance level of different factor values. Finally, utilizing the first factor influence coefficient and the second factor influence coefficient in combination with all running quality assessment factors in the factor set, the running quality assessment parameter for the current fingerprint access control can be obtained. This allows comprehensively considering the influence of various factors in the factor set on the running quality of the system, obtaining a comprehensive running quality assessment parameter.

The effects of the above technical solution are: By extracting running quality assessment factors continuously lower than a preset factor threshold to form a factor set, it is possible to accurately obtain factor information related to system running quality problems; by consolidating the running quality assessment factors lower than a preset reference factor value and the factors not lower than the reference factor value to form the first factor array and the second factor array, in combination with all running quality assessment factors in the factor set, it is possible to comprehensively consider the influence of multiple factors on the running quality of the system; by setting the first factor influence coefficient and the second factor influence coefficient, it is possible to give different weights according to the importance level of different factors, and in combination with the running quality assessment factor, obtain intelligent running quality assessment parameters, providing more accurate data support for decision-making; by monitoring and analyzing the running quality assessment factor of the operation and maintenance monitoring time period, when it is found that the running quality assessment factor is lower than a preset threshold, it is possible to timely extract relevant factor information and judge the running quality according to the assessment parameter, so as to timely take measures for optimization and improvement; by continuously monitoring the running quality assessment factor and timely evaluating the system running quality, it is possible to improve operation and maintenance efficiency and system stability, reduce the occurrence of faults and problems, and improve the reliability and availability of the system. The above formula for calculating the first factor influence coefficient is capable of comprehensively considering the difference in the number of factors and the factor values, flexibly allocating weights, highlighting the influence of important factors, and improving the accuracy of running quality assessment. At the same time, the first factor influence coefficient x₁ in the formula not only considers the number of factors k₁, but also considers the difference between the factor value Eⱼ and the reference factor value Eₑ. Therefore, it can more accurately reflect the importance level of factors on the running quality of the system; the values of the coefficient baseline value X₀ and the constant e in the formula can be adjusted to flexibly allocate the weights of different factors. If the coefficient baseline value X₀ is larger and the constant e is smaller, then the influence coefficient x₁ corresponding to factors with larger differences will also become larger, thus paying more attention to factors with larger differences; when the difference between the factor value Eᵢ of the factor and the reference factor value E_{c} is very large, the exponential operation in the formula will cause the influence coefficient x₁ to increase. This can highlight the influence of important factors on the running quality of the system and improve the sensitivity to system problems; by using this formula, it is possible, according to the comprehensive consideration of the number of factors and the factor values, to obtain a more accurate influence coefficient x₁, and in combination with the influence coefficients of other factors, further improve the accuracy of running quality assessment.

### Example 5

In this example, utilizing the said first factor influence coefficient and the said second factor influence coefficient in combination with all running quality assessment factors in the factor set to obtain the running quality assessment parameter for the current fingerprint access control comprises:
S316: extracting the said first factor influence coefficient and the said second factor influence coefficient;
S362: extracting all running quality assessment factors from the said factor set;
S363: utilizing all running quality assessment factors in the said factor set to obtain a running quality assessment parameter baseline value; wherein the said running quality assessment parameter baseline value is the average of the factors in the said factor set;
S364: utilizing the said assessment parameter baseline value in combination with the first factor influence coefficient and the second factor influence coefficient to obtain the running quality assessment parameter for the current fingerprint access control.

Wherein, the said running quality assessment parameter is obtained through the following formula:

$$Q = ( 1 - \frac{{x}_{1} - {x}_{2}}{{x}_{2}} ) \cdot {Q}_{0}$$

Wherein, Q represents the running quality assessment parameter;
Q₀ represents the running quality assessment parameter baseline value.

The working principle of the above technical solution is: The system will obtain various factors related to running quality in the fingerprint access control system, such as fingerprint recognition speed, false acceptance rate, hardware health status, etc., and use them as factors for running quality assessment; and perform weight analysis on these factors to obtain their influence coefficients in the assessment, namely the first factor influence coefficient and the second factor influence coefficient. And collect and organize all factors related to the running quality of the fingerprint access control system, forming a factor set. These factors may cover multiple aspects such as equipment performance, environmental factors, and usage conditions. Subsequently, perform statistics and analysis on all running quality assessment factors in the factor set, calculate their average value or other baseline values, as a reference standard for running quality assessment parameters. Finally, the system will combine the first factor influence coefficient and the second factor influence coefficient with the running quality assessment parameter baseline value, and calculate the running quality assessment parameter for the current fingerprint access control according to a certain algorithm or model. These parameters can be used to evaluate the running status of the system and guide subsequent maintenance and management work.

The effects of the above technical solution are: By extracting the first factor influence coefficient and the second factor influence coefficient, as well as the running quality assessment factor set, it is possible to turn running quality assessment into a systematic process, thereby improving the accuracy and reliability of the assessment; by utilizing all factors in the assessment factor set and using the average of the factors as the assessment parameter baseline value, comprehensive assessment of different factors can be performed, not only considering the influence of individual factors but also considering the combined effect of multiple factors; by utilizing the first factor influence coefficient and the second factor influence coefficient, the weights of different factors can be flexibly adjusted according to actual circumstances, thereby better adapting to different application scenarios and operating environments; by calculating the running quality assessment parameter for the current fingerprint access control, it is possible to timely understand the running status of the system and take corresponding measures for optimization and improvement according to the assessment results, to provide better user experience and system performance. Through the above formula, it is possible to quantitatively evaluate, compare and analyze, and real-time monitor changes in the running quality assessment parameter, and at the same time intuitively reflect the improvement effect of the technical solution on fingerprint image quality, providing effective indicators and basis for the application and optimization of the technical solution. At the same time, the above formula represents the running quality assessment parameter Q as a ratio relative to the baseline value Q₀, thus allowing quantitative evaluation of the effect of the said technical solution on fingerprint image quality improvement. Through numerical evaluation, it is possible to more intuitively understand the degree of influence of the technical solution on fingerprint images; the baseline value Q₀ can serve as a reference point, used to compare the running quality assessment parameter Q under different circumstances, thereby determining the improvement effect of the technical solution on fingerprint image quality under different conditions. This helps to perform comparative analysis, find out the optimal processing scheme, and perform technical tuning. Q in the formula can vary with the actual application situation of the technical solution and can serve as a real-time monitoring indicator to real-time monitor and evaluate the quality improvement effect on fingerprint images at different points in time or in different environments, thereby timely discovering problems and performing adjustment and optimization. The Q value calculated by the formula can intuitively reflect the improvement effect of the technical solution on fingerprint image quality, making the improvement effect more quantifiable and visualizable, facilitating the presentation and analysis of results.

### Example 6

In this example, a system for intelligent operation and maintenance of fingerprint access control, the said system for intelligent operation and maintenance of fingerprint access control comprises:
an Information Collection Module, configured to real-time acquire fingerprint identification data information of the fingerprint access control during each operation and maintenance monitoring time period;
a Quality Assessment Module, configured to utilize the said fingerprint identification data information at the end of each said operation and maintenance monitoring time period to obtain a running quality assessment factor corresponding to the said operation and maintenance monitoring time period;
a Parameter Acquisition Module, configured to, when the running quality assessment factor corresponding to a current preceding said operation and maintenance monitoring time period is lower than a preset factor threshold, then utilize the running quality assessment factors corresponding to each said operation and maintenance monitoring time period to obtain a running quality assessment parameter for the current fingerprint access control; and
a Maintenance Prompt Module, configured to, when the said running quality assessment parameter is lower than a preset assessment parameter threshold, then send a prompt for performing operation and maintenance on the said fingerprint access control to a staff terminal.

The working principle of the above technical solution is: By real-time acquiring fingerprint identification data information of the fingerprint access control, and then calculating the running quality assessment factor based on this data information. At the end of each operation and maintenance monitoring time period, according to the said fingerprint identification data information, the running quality assessment factor corresponding to that time period is calculated. If the running quality assessment factor is lower than a preset factor threshold, it indicates that there may be problems with the running quality of the fingerprint access control. In order to further evaluate the running status of the fingerprint access control, when the running quality assessment factor corresponding to an operation and maintenance monitoring time period is lower than a preset factor threshold, the running quality assessment parameter for the current fingerprint access control is obtained based on the running quality assessment factor of this time period. If the running quality assessment parameter is lower than a preset assessment parameter threshold, it indicates that there are significant problems with the running quality of the fingerprint access control. When the running quality assessment parameter of the fingerprint access control is lower than a preset assessment parameter threshold, a prompt for performing operation and maintenance on the said fingerprint access control will be sent to a staff terminal. This allows timely discovering and solving problems in the operation of the fingerprint access control, ensuring its normal operation and security.

The effects of the above technical solution are: By real-time acquiring fingerprint identification data information, it is possible to timely understand the usage and data statistics of the fingerprint access control equipment, which is beneficial for timely discovering problems and making operation and maintenance adjustments. Utilizing fingerprint identification data information to obtain the running quality assessment factor allows for objective evaluation of the running status of the fingerprint access control equipment, better understanding its stability and reliability. When the running quality assessment factor is lower than a preset factor threshold, the running quality assessment parameter can be obtained according to the said factor, further understanding the running quality of the fingerprint access control equipment. When the running quality assessment parameter is lower than a preset assessment parameter threshold, a prompt for operation and maintenance can be timely sent to a staff terminal, helping staff to timely troubleshoot and ensure the normal operation of the equipment. Through this solution, it is possible to improve the running efficiency and stability of the fingerprint access control equipment, reduce the probability of faults occurring, and improve the effectiveness of security and operating costs. By real-time monitoring the running status of the fingerprint access control, it is possible to timely discover potential problems, take preventive maintenance measures, avoid equipment damage or failure, and improve the lifespan and stability of the equipment; at the same time, by evaluating the running quality of the fingerprint access control, it is possible to understand the performance status of the equipment, optimize resource allocation, investing limited resources where they are most needed, and improving resource utilization efficiency; by real-time acquiring fingerprint identification data information and evaluating the running quality, it is possible to timely discover and solve potential security problems, enhance the security of the fingerprint access control system, and improve the security level; by analyzing and mining the collected fingerprint identification data information, more information and knowledge can be obtained, providing support and reference for decision-making and improving the scientificity and accuracy of decision-making.

### Example 7

In this example, the said Information Collection Module comprises:
a Time Setting Module, configured to set an operation and maintenance monitoring time period; wherein the value range of the said operation and maintenance monitoring time period is 90 days to 180 days; and
a Data Acquisition Module, configured to real-time acquire fingerprint identification data information of the fingerprint access control during each said operation and maintenance monitoring time period; wherein the said data information includes the accuracy of fingerprint identification, the response time length of each fingerprint identification, and the number of fingerprint identifications experienced by a single user to complete one access control opening and its corresponding fingerprint similarity determination result.

The working principle of the above technical solution is: setting the start and end time of each operation and maintenance monitoring time period in the system, wherein the value range of this time period is 90 days to 180 days. Operation and maintenance monitoring of the fingerprint access control will be performed during this period. Real-time acquisition of fingerprint identification data information: Within each operation and maintenance monitoring time period, the system real-time collects the fingerprint identification status of the fingerprint access control. The data information includes, but is not limited to, the accuracy of fingerprint identification, the response time length of each fingerprint identification, and the number of fingerprint identifications experienced by a single user during the access control opening process and its corresponding fingerprint similarity determination result, etc.

The effects of the above technical solution are: By setting an operation and maintenance time monitoring segment, the frequency and duration of monitoring can be flexibly adjusted to meet different scenarios and needs. Through real-time collection of fingerprint recognition data information from the fingerprint access control, the accuracy of fingerprint recognition can be timely understood, and abnormal situations can be monitored. If abnormal fingerprint recognition activity occurs, it can be immediately processed and responded to, thereby improving the security of the access control system. By collecting the response time length of each fingerprint recognition, the response speed of the access control system can be evaluated, and corresponding optimizations can be made based on the data results to enhance user experience. Accurate fingerprint recognition and a rapid access opening process can improve user satisfaction. By recording the number of fingerprint recognition attempts experienced by a single user to complete one access opening and the corresponding fingerprint similarity judgment results, the fingerprint recognition situation of each user can be analyzed. This helps to detect the reliability of user fingerprint information and provides data support to help solve existing problems in fingerprint recognition and improve recognition accuracy. Through continuous collection of fingerprint recognition data information from the fingerprint access control, operation and maintenance personnel can timely discover and solve potential problems, and carry out system operation, maintenance, and optimization work based on the data results. This helps to improve the stability and reliability of the access control system, reduce the occurrence of failures, and minimize the impact on user access.

### Example 8

In this example, the said Quality Assessment Module comprises:
an Information Extraction Module, configured to, at the end of each said operation and maintenance monitoring time period, extract the fingerprint identification data information of the fingerprint access control for a current preceding said operation and maintenance monitoring time period; and
a Quality Assessment Module, configured to utilize the said fingerprint identification data information to obtain the running quality assessment factor corresponding to the said operation and maintenance monitoring time period.
Wherein, the said running quality assessment factor is obtained through the following formula:

$$E = ( 1 + ln ( {e}^{P} + \frac{1}{n} \cdot {\sum }_{i = 1}^{n} ( \frac{{T}_{i} - {T}_{i - 1}}{Δ T} - \frac{{T}_{y} - Δ T}{max ( Δ T , {T}_{y} )} ) - \sqrt{\frac{1}{m} \cdot {\sum }_{i = 1}^{m} {( ( 1 - \frac{1}{{N}_{xi}} ) - \frac{1}{m} \cdot {\sum }_{i = 1}^{m} ( 1 - \frac{1}{{N}_{xi}} ) )}^{2}} ) ) \cdot {E}_{0}$$

Wherein, E represents the running quality assessment factor;
E₀ represents the factor baseline value;
P represents the accuracy of fingerprint identification;
n represents the number of fingerprint identifications within the operation and maintenance monitoring time period;
Tᵢ represents the response time length corresponding to the i-th fingerprint identification;
ΔT represents the theoretical response time delay caused by the network communication channel increasing a unit amount of data processing (1G) per unit time (1 s);
T_{y} represents the maximum allowable response delay for fingerprint identification;
m represents the number of identified users within the operation and maintenance monitoring time period;
Nₛᵢ represents the average number of fingerprint verifications experienced by the i-th user required to pass one fingerprint identification;
E₀ represents the factor baseline value.

The working principle of the above technical solution is: At the end of each operation and maintenance monitoring time period, the fingerprint identification data information for a current preceding operation and maintenance monitoring time period is extracted from the fingerprint access control system. This data information may include the accuracy of fingerprint identification, response time length, and fingerprint similarity determination results, etc. Utilizing the extracted fingerprint identification data information, the running quality assessment factor corresponding to the operation and maintenance monitoring time period is calculated.

The effects of the above technical solution are: By obtaining fingerprint identification data information and calculating the running quality assessment factor, quantitative evaluation of the performance and running quality of the access control system can be performed. This helps to discover problems and anomalies in the system, timely take measures to repair or improve them, and improve the stability and reliability of the system; utilizing the extracted fingerprint identification data information, the running quality of each operation and maintenance monitoring time period can be real-time monitored. By timely obtaining the running quality assessment factor, it is possible to understand the performance differences of the system in different time periods, timely discover and solve running problems, and ensure the normal operation of the system; by obtaining the running quality assessment factor corresponding to each operation and maintenance monitoring time period, it can provide reference and basis for operation and maintenance personnel, assisting them in making decisions and optimization. For example, when the running quality in a certain time period is low, targeted system maintenance, technical adjustment, or equipment upgrade can be performed to improve the overall performance and stability of the system; through the monitoring and evaluation of fingerprint identification data information, problems with the accuracy and reliability of fingerprint identification can be discovered, thereby improving the security and accuracy of the access control system. Timely discovering and correcting fingerprint identification anomalies can prevent unauthorized personnel from entering the system, increasing the security protection capability of the system. Through the above running quality assessment factor formula, the running quality assessment factor can be effectively calculated, comprehensively considering multiple factors, and flexibly adjusted according to needs, thereby helping operation and maintenance personnel to quantitatively evaluate the running quality of the system, timely discover problems and perform optimization. At the same time, the running quality assessment factor E in the formula can be calculated through parameters such as accuracy P, response time length Tᵢ, etc., capable of quantitatively evaluating the running quality of the system. In this way, operation and maintenance personnel can obtain a specific numerical value representing the quality level of the system's operation and use this as a baseline for monitoring and improvement; multiple factors are considered in the formula, including fingerprint identification accuracy, response time, processing capability of the communication channel, etc. In this way, the influence of factors from multiple aspects on system performance can be comprehensively considered, more comprehensively evaluating the running quality; the factor baseline value E0 in the formula can be adjusted according to specific circumstances. When demand changes, the assessment requirements of the operation and maintenance monitoring time period can be flexibly adapted by adjusting the baseline value, thereby more accurately evaluating the running quality; the running quality assessment factor calculated by the formula can be compared with a preset threshold to determine whether the system is operating in a good state. When the factor is lower than the threshold, it indicates that there may be problems with the system, requiring corresponding optimization and improvement. In this way, the reasons for the decline in running quality can be timely discovered, and measures can be taken to solve them, improving the performance and stability of the system.

### Example 9

In this example, the said Parameter Acquisition Module comprises:
a Set Formation Module, configured to, when the running quality assessment factor corresponding to a current preceding said operation and maintenance monitoring time period is lower than a preset factor threshold, extract the running quality assessment factors corresponding to all said operation and maintenance monitoring time periods experienced between the operation and maintenance monitoring time period where a current running quality assessment factor is lower than the preset factor threshold and the operation and maintenance monitoring time period where a previous running quality assessment factor was lower than the preset factor threshold, to form a factor set;
a First Factor Array Module, configured to extract the running quality assessment factors from the said factor set that are lower than a preset reference factor value and consolidate them into a first factor array;
a First Factor Influence Coefficient Module, configured to utilize the said first factor array to set a first factor influence coefficient; wherein the said first factor influence coefficient is obtained through the following formula:

$${x}_{1} = ( 1 + \frac{1}{{k}_{1}} \cdot {\sum }_{i = 1}^{{k}_{1}} ( 1 - {e}^{\frac{{E}_{e} - {E}_{i}}{{E}_{0}}} ) ) \cdot {X}_{0}$$

Wherein, x₁ represents the first factor influence coefficient;
k₁ represents the number of factors in the first factor array;
E_{c} represents the reference factor value;
X₀ represents the coefficient baseline value;
e represents a constant, with a value of 2.71;
Eᵢ represents the factor value of the i-th factor in the first factor array;
a Second Factor Array Module, configured to extract the running quality assessment factors from the said factor set that are not lower than a preset reference factor value and consolidate them into a second factor array;
a Second Factor Influence Coefficient Module, configured to utilize the said second factor array to set a second factor influence coefficient; wherein the said second factor influence coefficient is obtained through the following formula:

$${x}_{2} = ( 1 + \frac{1}{{k}_{2} \cdot {x}_{1}} \cdot {\sum }_{i = 1}^{{k}_{2}} ( 1 + {e}^{\frac{{E}_{e} - {E}_{j}}{{E}_{0}}} ) ) \cdot {X}_{0}$$

Wherein, x₂ represents the second factor influence coefficient;
k₁ represents the number of factors in the first factor array;
E_{c} represents the reference factor value;
X₀ represents the coefficient baseline value;
e represents a constant, with a value of 2.71;
k₂ represents the number of factors in the second factor array;
Eⱼ represents the factor value of the j-th factor in the second factor array;
an Operation Quality Assessment Module, configured to utilize the said first factor influence coefficient and the said second factor influence coefficient in combination with all running quality assessment factors in the factor set to obtain the running quality assessment parameter for the current fingerprint access control.

The working principle of the above technical solution is: According to a preset factor threshold, it is determined whether the running quality assessment factor within the current operation and maintenance monitoring time period is lower than the threshold. If it is lower than the threshold, it indicates that there are problems with the running quality of the system. When it is found that the current running quality assessment factor is lower than the threshold, it is necessary to extract the running quality assessment factors of all operation and maintenance monitoring time periods experienced between the operation and maintenance monitoring time period where the current running quality assessment factor is lower than the threshold and the previous operation and maintenance monitoring time period where the factor was lower than the threshold. This allows obtaining a factor set, which includes the running quality assessment factors that are continuously below the threshold. The running quality assessment factors in the factor set that are lower than a preset reference factor value are consolidated into a first factor array. This allows extracting a portion of the running quality assessment factors used for determining the first factor influence coefficient. The running quality assessment factors in the factor set that are not lower than a preset reference factor value are consolidated into a second factor array. This allows extracting a portion of the running quality assessment factors used for determining the second factor influence coefficient. Utilizing the first factor array to set the first factor influence coefficient, and utilizing the second factor array to set the second factor influence coefficient. This allows assigning different influence coefficients according to the importance level of different factor values. Finally, utilizing the first factor influence coefficient and the second factor influence coefficient in combination with all running quality assessment factors in the factor set, the running quality assessment parameter for the current fingerprint access control can be obtained. This allows comprehensively considering the influence of various factors in the factor set on the running quality of the system, obtaining a comprehensive running quality assessment parameter.

The effects of the above technical solution are: By extracting running quality assessment factors continuously lower than a preset factor threshold to form a factor set, it is possible to accurately obtain factor information related to system running quality problems; by consolidating the running quality assessment factors lower than a preset reference factor value and the factors not lower than the reference factor value to form the first factor array and the second factor array, in combination with all running quality assessment factors in the factor set, it is possible to comprehensively consider the influence of multiple factors on the running quality of the system; by setting the first factor influence coefficient and the second factor influence coefficient, it is possible to give different weights according to the importance level of different factors, and in combination with the running quality assessment factor, obtain intelligent running quality assessment parameters, providing more accurate data support for decision-making; by monitoring and analyzing the running quality assessment factor of the operation and maintenance monitoring time period, when it is found that the running quality assessment factor is lower than a preset threshold, it is possible to timely extract relevant factor information and judge the running quality according to the assessment parameter, so as to timely take measures for optimization and improvement; by continuously monitoring the running quality assessment factor and timely evaluating the system running quality, it is possible to improve operation and maintenance efficiency and system stability, reduce the occurrence of faults and problems, and improve the reliability and availability of the system. The above formula for calculating the first factor influence coefficient is capable of comprehensively considering the difference in the number of factors and the factor values, flexibly allocating weights, highlighting the influence of important factors, and improving the accuracy of running quality assessment. At the same time, the first factor influence coefficient x₁ in the formula not only considers the number of factors k₁, but also considers the difference between the factor value Eᵢ and the reference factor value Eₑ. Therefore, it can more accurately reflect the importance level of factors on the running quality of the system; the values of the coefficient baseline value X₀ and the constant e in the formula can be adjusted to flexibly allocate the weights of different factors. If the coefficient baseline value X₀ is larger and the constant e is smaller, then the influence coefficient x₁ corresponding to factors with larger differences will also become larger, thus paying more attention to factors with larger differences; when the difference between the factor value Eᵢ of the factor and the reference factor value Eₑ is very large, the exponential operation in the formula will cause the influence coefficient x₁ to increase. This can highlight the influence of important factors on the running quality of the system and improve the sensitivity to system problems; by using this formula, it is possible, according to the comprehensive consideration of the number of factors and the factor values, to obtain a more accurate influence coefficient x₁, and in combination with the influence coefficients of other factors, further improve the accuracy of running quality assessment.

### Example 10

In this example, the said Operation Quality Assessment Module comprises:
a Coefficient Extraction Module, configured to extract the said first factor influence coefficient and the said second factor influence coefficient;
a Factor Extraction Module, configured to extract all running quality assessment factors from the said factor set;
a Baseline Value Acquisition Module, configured to utilize all running quality assessment factors in the said factor set to obtain a running quality assessment parameter baseline value; wherein the said running quality assessment parameter baseline value is the average of the factors in the said factor set; and
an Assessment Parameter Acquisition Module, configured to utilize the said assessment parameter baseline value in combination with the first factor influence coefficient and the second factor influence coefficient to obtain the running quality assessment parameter for the current fingerprint access control.
Wherein, the said running quality assessment parameter is obtained through the following formula:

$$Q = ( 1 - \frac{{x}_{1} - {x}_{2}}{{x}_{2}} ) \cdot {Q}_{0}$$

Here are the English translations for the variable definitions and the working principle description for Example 10. These are identical to the translations provided earlier for Example 5, as the Chinese text is the same.
Wherein, Q represents the running quality assessment parameter;
Q₀ represents the running quality assessment parameter baseline value.

The working principle of the above technical solution is: The system will obtain various factors related to running quality in the fingerprint access control system, such as fingerprint recognition speed, false acceptance rate, hardware health status, etc., and use them as factors for running quality assessment; and perform weight analysis on these factors to obtain their influence coefficients in the assessment, namely the first factor influence coefficient and the second factor influence coefficient. And collect and organize all factors related to the running quality of the fingerprint access control system, forming a factor set. These factors may cover multiple aspects such as equipment performance, environmental factors, and usage conditions. Subsequently, perform statistics and analysis on all running quality assessment factors in the factor set, calculate their average value or other baseline values, as a reference standard for running quality assessment parameters. Finally, the system will combine the first factor influence coefficient and the second factor influence coefficient with the running quality assessment parameter baseline value, and calculate the running quality assessment parameter for the current fingerprint access control according to a certain algorithm or model. These parameters can be used to evaluate the running status of the system and guide subsequent maintenance and management work.

The effects of the above technical solution are: By extracting the first factor influence coefficient and the second factor influence coefficient, as well as the running quality assessment factor set, it is possible to turn running quality assessment into a systematic process, thereby improving the accuracy and reliability of the assessment; by utilizing all factors in the assessment factor set and using the average of the factors as the assessment parameter baseline value, comprehensive assessment of different factors can be performed, not only considering the influence of individual factors but also considering the combined effect of multiple factors; by utilizing the first factor influence coefficient and the second factor influence coefficient, the weights of different factors can be flexibly adjusted according to actual circumstances, thereby better adapting to different application scenarios and operating environments; by calculating the current fingerprint access control's running quality assessment parameter, it is possible to timely understand the system's running status, and according to the assessment results, take corresponding measures for optimization and improvement, to provide better user experience and system performance. Through the above formula, it is possible to quantitatively evaluate, compare and analyze, and real-time monitor changes in the running quality assessment parameter, and at the same time intuitively reflect the improvement effect of the technical solution on fingerprint image quality, providing effective indicators and basis for the application and optimization of the technical solution. At the same time, the above formula represents the running quality assessment parameter Q as a ratio relative to the baseline value Q₀, thus allowing quantitative evaluation of the effect of the said technical solution on fingerprint image quality improvement. Through numerical evaluation, it is possible to more intuitively understand the degree of influence of the technical solution on fingerprint images; the baseline value Q₀ can serve as a reference point, used to compare the running quality assessment parameter Q under different circumstances, thereby determining the improvement effect of the technical solution on fingerprint image quality under different conditions. This helps to perform comparative analysis, find out the optimal processing scheme, and perform technical tuning. Q in the formula can vary with the actual application situation of the technical solution and can serve as a real-time monitoring indicator to real-time monitor and evaluate the quality improvement effect on fingerprint images at different points in time or in different environments, thereby timely discovering problems and performing adjustment and optimization. The Q value calculated by the formula can intuitively reflect the improvement effect of the technical solution on fingerprint image quality, making the improvement effect more quantifiable and visualizable, facilitating the presentation and analysis of results.

The following is the translation of the concluding paragraph:

Obviously, those skilled in the art can make various changes and modifications to the present invention without departing from the spirit and scope of the present invention. Thus, if¹ these modifications and variations of the present invention fall within the scope of the claims of the present invention and their equivalent² technologies, then the present invention is also intended to include these changes and variations.

1. A method for intelligent operation and maintenance of fingerprint access control, characterized in that the method for intelligent operation and maintenance of fingerprint access control comprises:
real-time acquisition of fingerprint identification data information of the fingerprint access control during each operation and maintenance monitoring time period;
utilizing the said fingerprint identification data information at the end of each said operation and maintenance monitoring time period to obtain a running quality assessment factor corresponding to the said operation and maintenance monitoring time period;
when the running quality assessment factor corresponding to a current preceding said operation and maintenance monitoring time period is lower than a preset factor threshold, then utilizing the running quality assessment factors corresponding to each said operation and maintenance monitoring time period to obtain a running quality assessment parameter for the current fingerprint access control;
when the said running quality assessment parameter is lower than a preset assessment parameter threshold, then sending a prompt for performing operation and maintenance on the said fingerprint access control to a staff terminal.

2. The method for intelligent operation and maintenance of fingerprint access control according to claim 1, characterized in that the real-time acquisition of fingerprint identification data information of the fingerprint access control during each operation and maintenance monitoring time period comprises:
setting an operation and maintenance monitoring time period; wherein the value range of the said operation and maintenance monitoring time period is 90 days to 180 days; and
real-time acquisition of fingerprint identification data information of the fingerprint access control during each said operation and maintenance monitoring time period; wherein the said data information includes the accuracy of fingerprint identification, the response time length of each fingerprint identification, and the number of fingerprint identifications experienced by a single user to complete one access control opening and its corresponding fingerprint similarity determination result.

3. The method for intelligent operation and maintenance of fingerprint access control according to claim 1, characterized in that utilizing the said fingerprint identification data information at the end of each said operation and maintenance monitoring time period to obtain the running quality assessment factor corresponding to the said operation and maintenance monitoring time period comprises:
at the end of each said operation and maintenance monitoring time period, extracting the fingerprint identification data information of the fingerprint access control for a current preceding said operation and maintenance monitoring time period; and
utilizing the said fingerprint identification data information to obtain the running quality assessment factor corresponding to the said operation and maintenance monitoring time period.

4. The method for intelligent operation and maintenance of fingerprint access control according to claim 1, characterized in that when the running quality assessment factor corresponding to a current preceding said operation and maintenance monitoring time period is lower than a preset factor threshold, then utilizing the running quality assessment factors corresponding to each said operation and maintenance monitoring time period to obtain the running quality assessment parameter for the current fingerprint access control comprises:
when the running quality assessment factor corresponding to a current preceding said operation and maintenance monitoring time period is lower than a preset factor threshold, extracting the running quality assessment factors corresponding to all said operation and maintenance monitoring time periods experienced between the operation and maintenance monitoring time period where a current running quality assessment factor is lower than the preset factor threshold and the operation and maintenance monitoring time period where a previous running quality assessment factor was lower than the preset factor threshold, to form a factor set;
extracting the running quality assessment factors from the said factor set that are lower than a preset reference factor value and consolidating them into a first factor array;
utilizing the said first factor array to set a first factor influence coefficient;
extracting the running quality assessment factors from the said factor set that are not lower than the preset reference factor value and consolidating them into a second factor array;
utilizing the said second factor array to set a second factor influence coefficient; and
utilizing the said first factor influence coefficient and the said second factor influence coefficient in combination with all running quality assessment factors in the factor set to obtain the running quality assessment parameter for the current fingerprint access control.

5. The method for intelligent operation and maintenance of fingerprint access control according to claim 4, characterized in that utilizing the said first factor influence coefficient and the said second factor influence coefficient in combination with all running quality assessment factors in the factor set to obtain the running quality assessment parameter for the current fingerprint access control comprises:
extracting the said first factor influence coefficient and the said second factor influence coefficient;
extracting all running quality assessment factors from the said factor set;
utilizing all running quality assessment factors in the said factor set to obtain a running quality assessment parameter baseline value; and
utilizing the said assessment parameter baseline value in combination with the first factor influence coefficient and the second factor influence coefficient to obtain the running quality assessment parameter for the current fingerprint access control.

6. A system for intelligent operation and maintenance of fingerprint access control, characterized in that the system for intelligent operation and maintenance of fingerprint access control comprises:
an Information Collection Module, configured to real-time acquire fingerprint identification data information of the fingerprint access control during each operation and maintenance monitoring time period;
a Quality Assessment Module, configured to utilize the said fingerprint identification data information at the end of each said operation and maintenance monitoring time period to obtain a running quality assessment factor corresponding to the said operation and maintenance monitoring time period;
a Parameter Acquisition Module, configured to, when the running quality assessment factor corresponding to a current preceding said operation and maintenance monitoring time period is lower than a preset factor threshold, then utilize the running quality assessment factors corresponding to each said operation and maintenance monitoring time period to obtain a running quality assessment parameter for the current fingerprint access control; and
a Maintenance Prompt Module, configured to, when the said running quality assessment parameter is lower than a preset assessment parameter threshold, then send a prompt for performing operation and maintenance on the said fingerprint access control to a staff terminal.

7. The system for intelligent operation and maintenance of fingerprint access control according to claim 6, characterized in that the said Information Collection Module comprises:
a Time Setting Module, configured to set an operation and maintenance monitoring time period; wherein the value range of the said operation and maintenance monitoring time period is 90 days to 180 days; and
a Data Acquisition Module, configured to real-time acquire fingerprint identification data information of the fingerprint access control during each said operation and maintenance monitoring time period; wherein the said data information includes the accuracy of fingerprint identification, the response time length of each fingerprint identification, and the number of fingerprint identifications experienced by a single user to complete one access control opening and its corresponding fingerprint similarity determination result.

8. The system for intelligent operation and maintenance of fingerprint access control according to claim 6, characterized in that the said Quality Assessment Module comprises:
an Information Extraction Module, configured to, at the end of each said operation and maintenance monitoring time period, extract the fingerprint identification data information of the fingerprint access control for a current preceding said operation and maintenance monitoring time period; and
a Quality Assessment Module, configured to utilize the said fingerprint identification data information to obtain the running quality assessment factor corresponding to the said operation and maintenance monitoring time period.

9. The system for intelligent operation and maintenance of fingerprint access control according to claim 6, characterized in that the said Parameter Acquisition Module comprises:
a Set Formation Module, configured to, when the running quality assessment factor corresponding to a current preceding said operation and maintenance monitoring time period is lower than a preset factor threshold, extract the running quality assessment factors corresponding to all said operation and maintenance monitoring time periods experienced between the operation and maintenance monitoring time period where a current running quality assessment factor is lower than the preset factor threshold and the operation and maintenance monitoring time period where a previous running quality assessment factor was lower than the preset factor threshold, to form a factor set;
a First Factor Array Module, configured to extract the running quality assessment factors from the said factor set that are lower than a preset reference factor value and consolidate them into a first factor array;
a First Factor Influence Coefficient Module, configured to utilize the said first factor array to set a first factor influence coefficient;
a Second Factor Array Module, configured to extract the running quality assessment factors from the said factor set that are not lower than the preset reference factor value and consolidate them into a second factor array;
a Second Factor Influence Coefficient Module, configured to utilize the said second factor array to set a second factor influence coefficient; and
an Operation Quality Assessment Module, configured to utilize the said first factor influence coefficient and the said second factor influence coefficient in combination with all running quality assessment factors in the factor set to obtain the running quality assessment parameter for the current fingerprint access control.

10. The system for intelligent operation and maintenance of fingerprint access control according to claim 9, characterized in that the said Operation Quality Assessment Module comprises:
a Coefficient Extraction Module, configured to extract the said first factor influence coefficient and the said second factor influence coefficient;
a Factor Extraction Module, configured to extract all running quality assessment factors from the said factor set;
a Baseline Value Acquisition Module, configured to utilize all running quality assessment factors in the said factor set to obtain a running quality assessment parameter baseline value; and
an Assessment Parameter Acquisition Module, configured to utilize the said assessment parameter baseline value in combination with the first factor influence coefficient and the second factor influence coefficient to obtain the running quality assessment parameter for the current fingerprint access control.
